(19) United States
(12) Patent Application Publication
(10) Pub. No.: US 2009/0070199 A1
(43) Pub. Date: Mar. 12, 2009

(54) Adult care information system and method

(75) Inventor: Ali Zamani, Portland, OR (US)

Correspondence Address: ATER WYNNE LLP, 1331 NW Lovejoy St. Suite 900, PORTLAND, OR, 97209-2785, US

(73) Assignee: Adult-Care.Org. Inc.

(21) Appl. No.: 12/215,571

(22) Filed: Jun. 26, 2008

Related U.S. Application Data
(60) Provisional application No. 60/937,374, filed on Jun. 26, 2007.

(51) Int. Cl. G06Q 10/00; G06Q 30/00

(52) U.S. Cl. 705/10; 705/7; 705/26

(57) ABSTRACT

A system and method for providing consumer-based, adult care provider-relevant information in a consolidated format to potential users (e.g., customers, responsible parties, government evaluators, etc.) of adult healthcare facilities and/or services. A system and method typically enables healthcare providers and others to provide information and for users to obtain information via devices interfacing with a relatively centralized, network-connected, server-based presence.

### RELATED APPLICATIONS

This application claims the benefit of priority to U.S. Provisional application No. 60/937,374, filed on Jun. 26, 2007 and entitled ADULT CARE INFORMATION SYSTEM AND METHOD, the contents of which are hereby incorporated herein in their entirety by this reference.

### FIELD OF THE INVENTION

The invention relates generally to the field of providing healthcare information. In particular, the invention relates to a network-based system and method for providing information relevant to adult healthcare facilities.

### BACKGROUND OF THE INVENTION

The market for information regarding adult care facilities and services (collectively, providers) constitutes a frustrating game of hide-and-seek. This includes information such as the types of services provided and availability to receive new customers. Many providers do not advertise aggressively, so the general public does not have such awareness thrust at them. Likewise, many providers, and particularly many of those providing the best care, are relatively small and unknown beyond their current customers and/or immediate geographic areas. Further, it is frequently difficult for a potential customer to obtain information about providers located outside their immediate area. New potential customers must resort to searching through phone directories, relying on “word-of-mouth” recommendations, and generally chasing widely dispersed and perhaps unreliable sources of information. However, adult care needs may be urgent in some situations, allowing little time for wide-ranging and ad-hoc research efforts.

Further, the quality of care provided by adult care providers is of paramount concern to potential customers. News stories detailing sub-standard conditions and/or services by this provider or that are not at all infrequent. And those providers that most actively advertise themselves may not provide an entirely accurate portrayal of the level and quality of care that customers can expect to receive. Indeed, poor quality of care may be the reason a provider is forced to actively advertise, due to the inability to retain customers. The most reliable information on provider quality may come from reviews provided by current and/or prior customers, but such reviews may be difficult to locate, “cherry-picked” by the facility, or simply non-existent.

Therefore, those seeking adult care providers for themselves or family members currently do not have a simple to use, reliable, and consolidated source of information regarding adult healthcare providers.

### BRIEF DESCRIPTION OF THE DRAWINGS

FIG. 1 depicts in block diagram form an adult care information system according to an embodiment of the invention.

FIG. 2 depicts in block diagram form functional means and devices included in an adult care information system according to an embodiment of the invention.

FIGS. 3-20 depict in screen capture form a plurality of features of an adult care information system and method as depicted by graphical user interfaces according to embodiments of the invention.

### DETAILED DESCRIPTION OF THE PREFERRED EMBODIMENTS

The invention in accordance with a preferred embodiment involves a system and method for providing consumer-based, adult care provider-relevant information in a consolidated format to potential users (e.g., customers, responsible parties, government evaluators, etc.) of adult healthcare facilities and/or services.

It will be understood that the present invention is not limited to the specific embodiments described and illustrated herein. Indeed, any suitable variation of arrangement, use, or application is contemplated as an alternative embodiment, and thus is within the spirit and scope, of the invention.

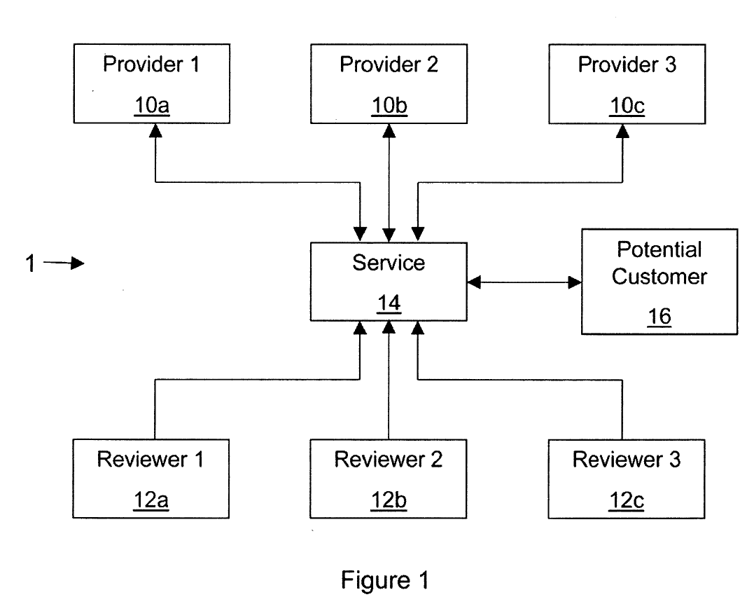

With reference to FIG. 1, an adult care information system 1 includes a plurality of adult care providers 10a-c (collectively hereinafter, providers 10). Such providers 10 can include nursing homes, assisted living facilities, residential care services, hospices, and foster care, although the embodiments are not so limited. Therefore, providers 10 can include relatively centralized facilities with services provided to potential consumers (hereinafter, users) thereat, or can include services provided at a user's residence or another location.

Each provider 10 provides information to an information consolidator/provider 14 (hereinafter, Service 14), either self-initiated or in response to an information request (e.g., a survey, an interview, etc.) from the Service 14. Provider-relevant information can include such provider-relevant information as level of care, capacity, food quality, staff qualifications, accreditation, medical care capabilities, accommodations for disabilities, and other information. Such information can be provided by providers 10 to a Service 14 vocally, by printed media, on digital storage media, or as data transmitted across a networking means (e.g., internet, proprietary network, radio-frequency network, or another network), although the embodiments are not so limited.

Generally, according to an embodiment, a provider 10 will pay a subscription fee to a Service 14 to have the provider's information made available to users 16, to have the provider's name and/or other identifying data presented to potential consumers who access Service 14 provided information, or for other benefits. For example, a Service 14 may set a price scale for providers 10 based at least in part on the amount of provider information, or types of provider information received and made available to users 16, or the positioning of provider information relative to the information of other providers 10 (i.e., a placement premium).

However received from a provider 10 at a Service 14, the information can be converted to and stored as data at a memory means (e.g., magnetic or optical storage media, solid-state memory devices such as EPROM, Flash, or other chip devices, etc.) enabling the information to be accessed, retrieved, and processed by a data processing means. For example, stored data can be retrieved and organized according to a particular provider, according to a hierarchy of consumer ratings, or in other conceived ways too numerous to list here.

Because many users 16 appreciate obtaining information from numerous current and/or former consumer/reviewers 12a-c (hereinafter, reviewers 12) of adult care providers 10. Users 16 may find reviewer 12 information more credible than that provided by providers 10 themselves, if not simply adding context to the provider 10 provided information. Therefore, a system 1 according to embodiments also includes collecting information from such reviewers 12. Typically, such information collection will be in the form of reviews, ratings, personal testimonials, and other forms. A Service 14 can either actively solicit reviewer 12 input, such as by sending email messages with information requests, or may provide an information input means that reviewers 12 can access and use to submit information at their own initiative. For example, and embodiment of the invention includes an internet-enabled information submission portal with queries to guide reviewers 12 to provide specific types of information according to specific parameters (e.g., sequence, word and/or character limits, etc.).

As shown by the arrows in FIG. 1, information can flow either uni-directionally or bi-directionally along information pathways of a network means between a Service 14 and each of providers 10, reviewers 12, and potential customers 16.

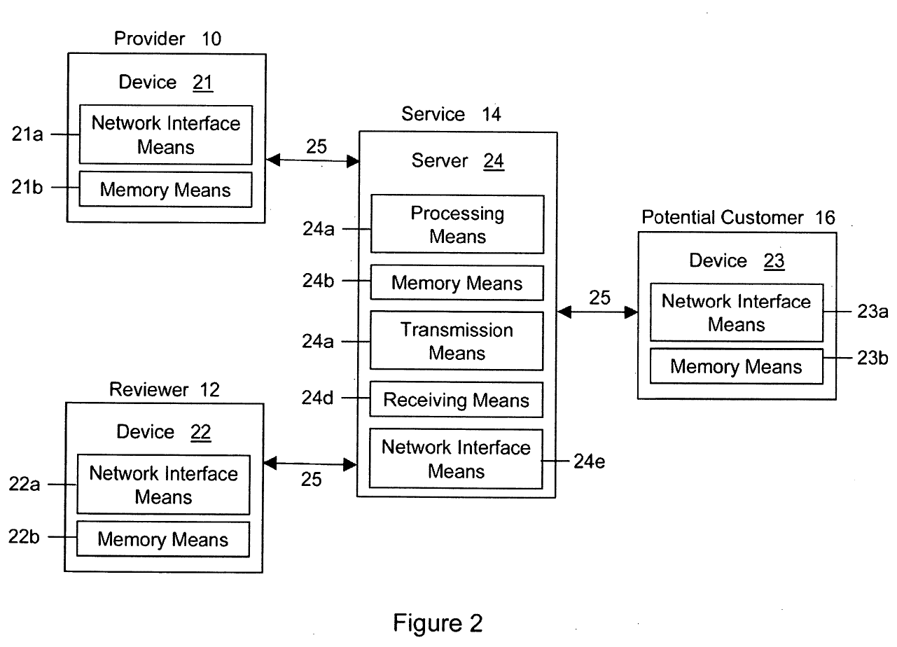

With reference to FIG. 2, each of providers 10, reviewers 12, and potential customers 16 have or have access to a data processing device 21-23 (e.g., computer, personal digital assistant, etc.) (hereinafter, computer 21-23) operatively coupled with a network means 25, and including a network interface means 21a-23a. Broadly speaking, a computer 21-23 can include nearly any network-capable data processing device, including mobile telephones (e.g., internet capable mobile phones). A network interface means 21a-23a (hereinafter, browser 21a-23a) will typically but not exclusively be an internet browser utility comprising computer-executable code residing at a memory means 21b-23b of the computer 21-23. When executed by a computer 21-23 according to embodiments, the code causes the computer to access a server 24 of Service 14 via a network means 25 (e.g., wireless transmitting and/or receiving devices and/or systems, wired and/or optical signal conveying media and/or devices, etc.).

A server 24 of a Service 14, according to embodiments, includes such structural and functional elements as a data processing means 24a, a memory means 24b, a data transmission means 24c, a data receiving means 24d, and a network interface means 24e, integrated with and/or operatively coupled one another. A data processing means 24a includes any device and/or computer executable code configured to act upon or in response to data, such as by analyzing, altering, augmenting, cross-checking or filtering, although the embodiments are not so limited. A memory means 24b is any media and/or device at which data can be stored and/or from which data can be retrieved, as are known in the art. Transmission means 24c and receiving means 24d include any device and or apparatus configured to transmit and/or receive data with and/or via a network means 25. A network interface means 24e can be embodied in either hardware or software (e.g., an internet browser), or some combination thereof, and enables operatively coupling with and/or interacting with remote entities across a network.

Provider-relevant information submitted to a Service 14 by providers 10 and/or reviewers 12 is generally received at a receiving means 24d, stored at the memory means 24b of the server 24, and processed by a processing means 24a prior to storage. Both providers 10 and reviewers 12 can submit such information at an internet-accessible web page configured as part of a server's network interface means 24e.

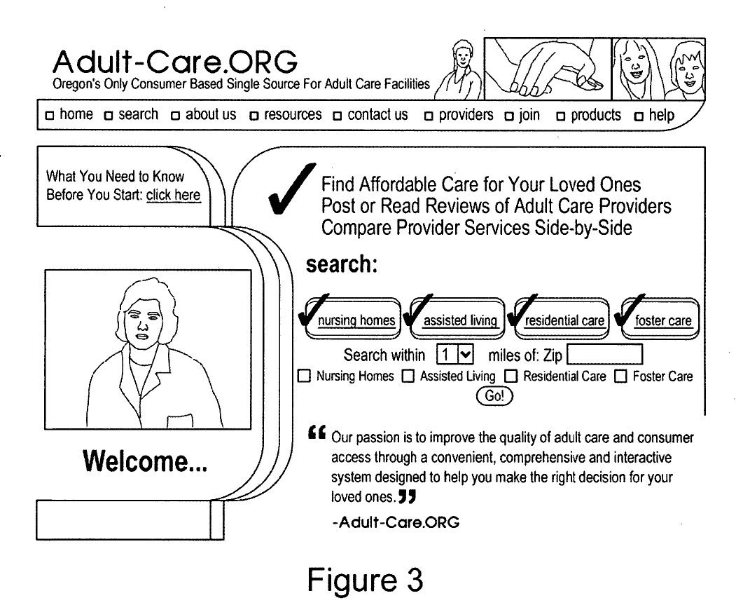

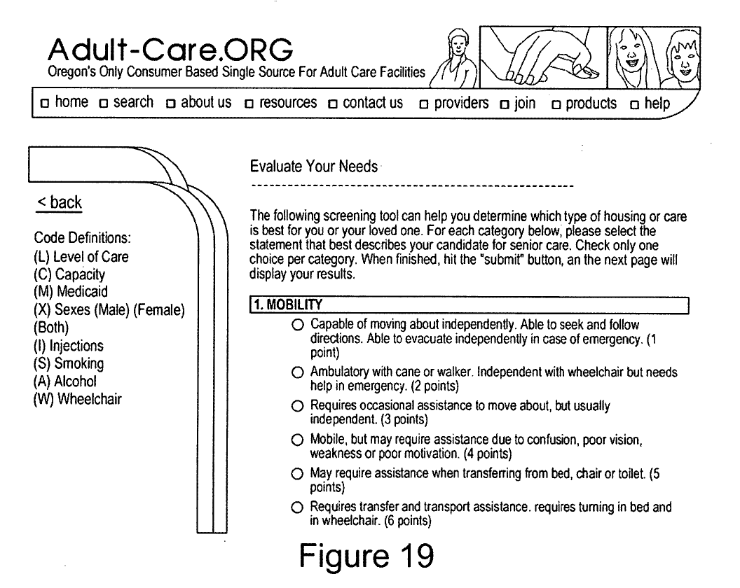

An adult care information system according to an embodiment can be more easily understood by reference to FIGS. 3-21, which depict various aspects of the invention. For example, FIG. 3 depicts a relatively centralized portal enabled by and providing further access to an embodiment of an adult care information system. As shown in FIG. 3, a potential customer can select from among a plurality of adult care provider designations to research and compare the relative merits of providers listed under each option. These designations include, but are not limited to, nursing homes, assisted living, residential care, and foster care. Additionally, computer executable code stored at a memory means 24b of the server 24 enables system filtering of search results based upon user input criteria, such as distance criteria and location criteria (e.g., search within 1-n miles of a specified zip code).

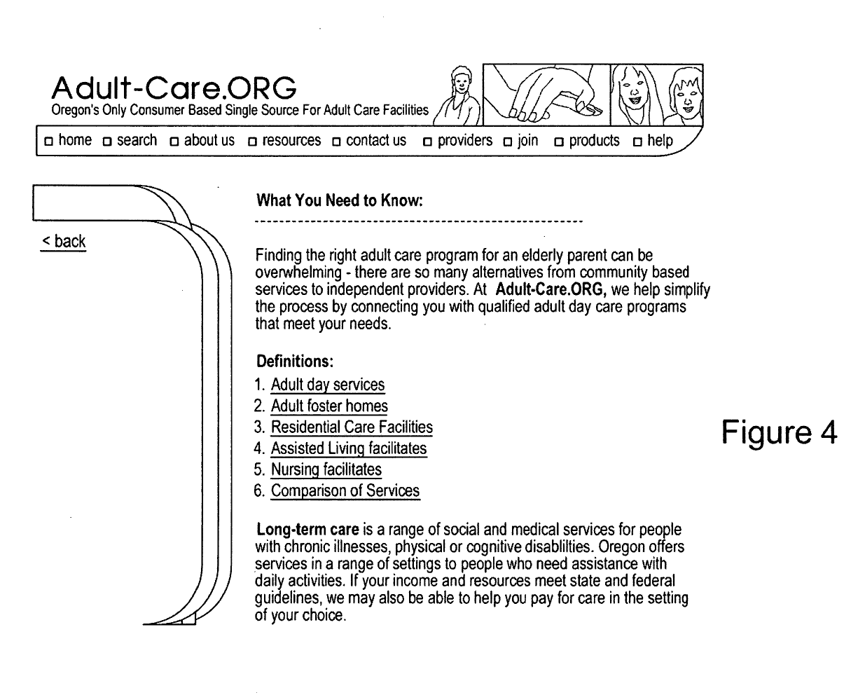

To help a user designate the appropriate parameter(s) and execute the appropriate search intended by the user, as shown at FIG. 4, definitions or active hyperlinks to definitions are provided for each type of provider designation. Each hyperlinked designation, for example, when selected and executed causes a corresponding and typically unique subset of provider-relevant data to display at a display means of a user device 23. Therefore, the definitions ensure that user 16 is able to execute the proper device-executable code that will cause a display to present a subset of provider-relevant data corresponding to the user's 16 intended inquiry.

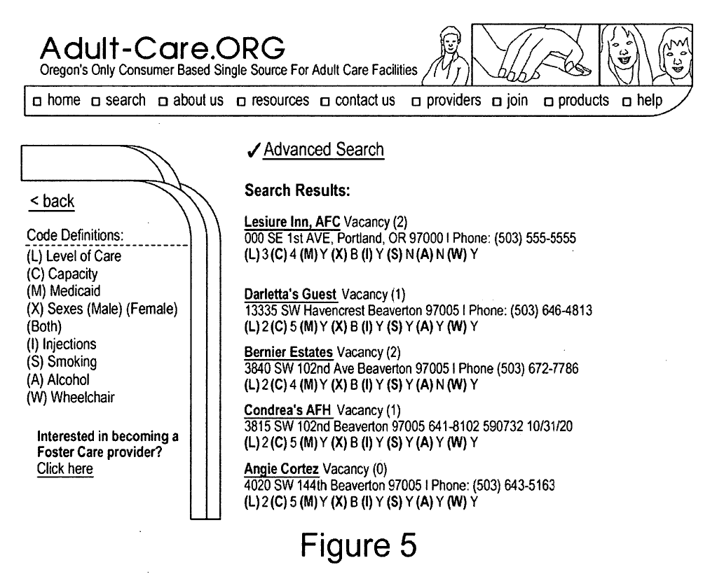

An example of a provider-relevant data subset is shown at FIG. 5. A list of provider facilities and/or services is presented to the user at a display means of the user's device 23. Associated with each provider listing (e.g., Leisure Inn, AFC) are data providing information that a user may find useful for comparing providers and/or selecting a provider. For example, a provider listing can include location and contact information (e.g., address and telephone number), a vacancy status (e.g., number of current vacancies), and one or more feature indicators (e.g., L=Level of Care) and an associated quantifying and/or qualifying value (e.g., Y=Yes), although the embodiments are not so limited. A legend/key may also be provided in embodiments to assist users in understanding the presented data, as shown in the embodiment of FIG. 5.

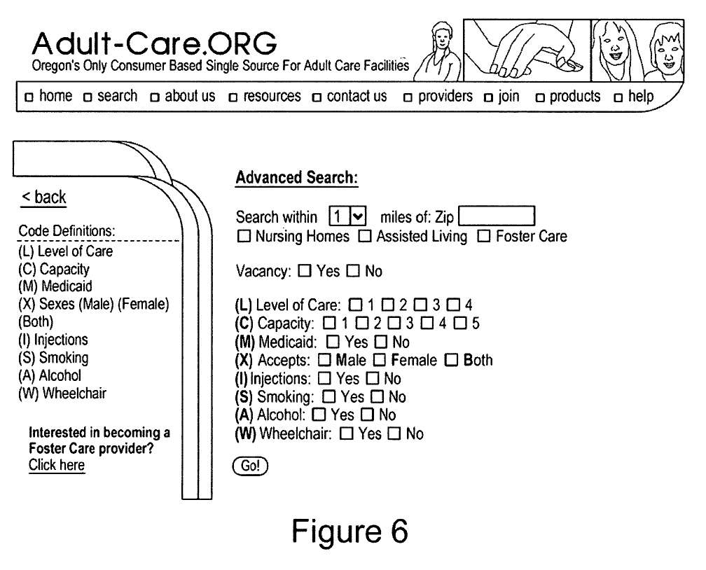

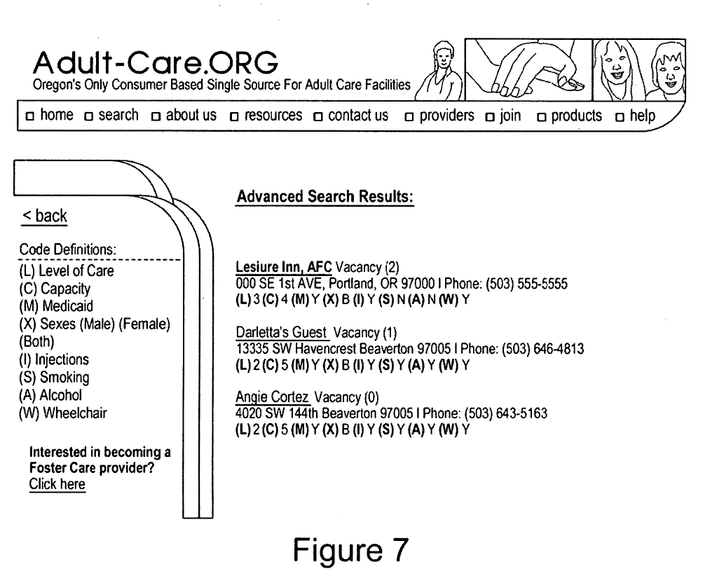

As shown at FIG. 6, a system may also be configured to enable an advanced search. Therefore, a user can cause the system to execute a more discriminatory search based at least in part upon user selected/specified qualifying and/or quantifying values. A search executed according to such user specified parameters will typically cause the system to return, and the user device display to present to the user, only results complying those selected parameters and excluding non-compliant results. Therefore, the user's search for adult care provider information is rendered more efficient and effective. For example, FIG. 7 depicts an advances search result corresponding to user specified search parameters, representing a more user-relevant subset of the search results depicted according to the embodiment of FIG. 5.

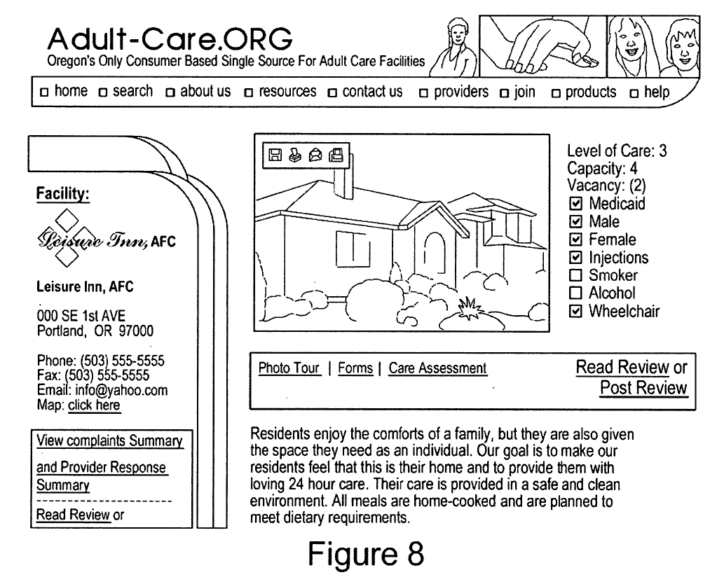

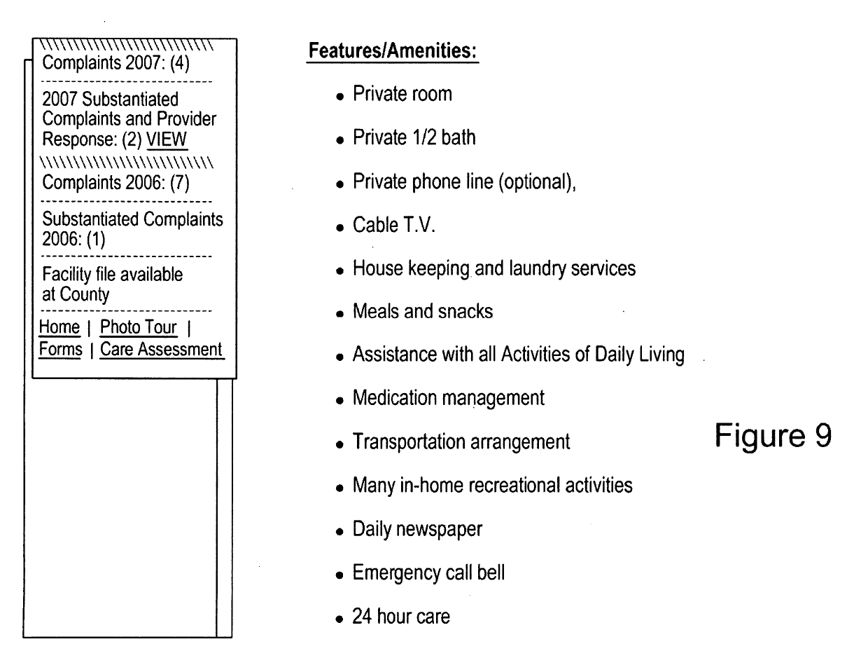

From a set of search results, a user can individually select a listing (e.g., Leisure Inn, AFC) and view provider-relevant data at a more detailed and informative level, as shown sequentially in FIGS. 8 and 9. Such data can include photographs of the interior and/or exterior of the provider facility, a provider-provided or service-provided (for example) description of the facility/provider/service, additional contact information and/or active links to additional information (e.g., URL), reviews of the provider, relevant forms, and other information. It should be clear to one having skill in the art that the information depicted in and/or depicted as accessible in FIGS. 8 and 9 represent only one embodiment, and a nearly unlimited variety of information can be provided according to alternative embodiments.

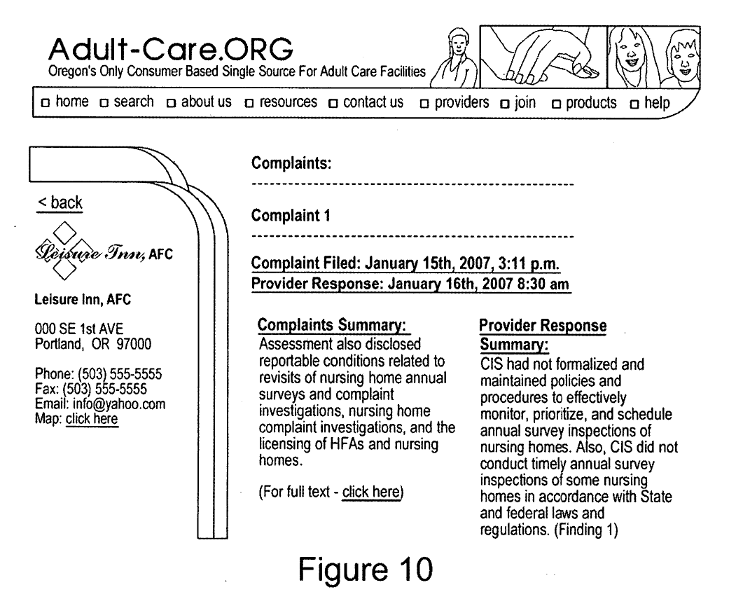

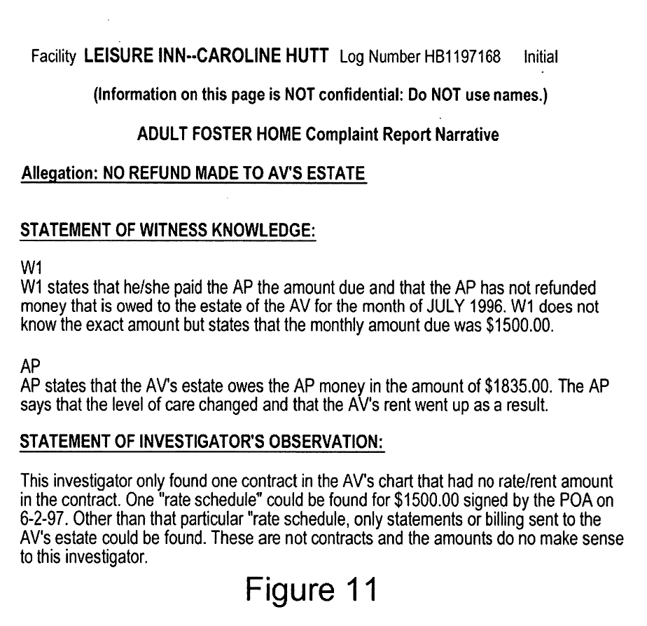

FIG. 10 shows an example of important information available in an embodiment that would typically be practically impossible for a user to obtain according to the prior art, but is easily enabled by embodiment of the invented system. For example, the user can select an active link to complaints relative to a provider, such as submitted by previous customers of the provider, or by government inspectors for example, and review the details of each complaint including provider-submitted responses to the complaint(s). Either summaries or full-text of each complaint and/or response can be presented to the user, along with other relevant information, such as the dates each was submitted. FIG. 11 also depicts an example of details and results of an investigation conducted relative to a provider. Such information helps to educate users not only of past issues relative to specific providers, but also educates users regarding key questions to ask and information to pursue prior to selecting an adult care provider. Therefore, embodiments of the invented system not only enable users to easily obtain substantial and diverse information related to adult care providers, but also teaches users how to be more savvy consumers of those services, including what to look for and how to assess the information they obtain.

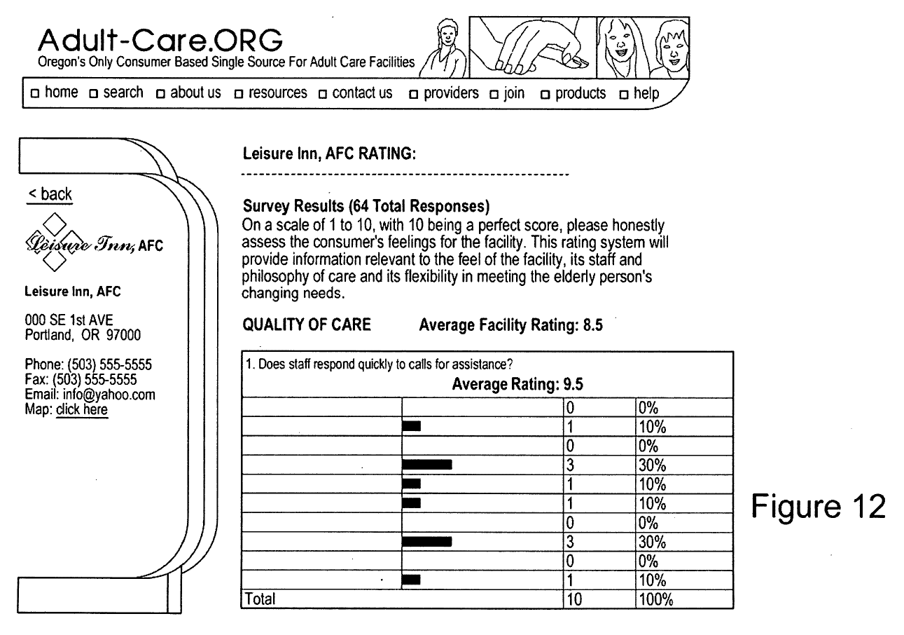

FIG. 12 depicts an embodiment of a rating of a provider 10 by a service 14 with regard to a “Quality of Care” parameter. The rating is, in embodiments, based at least in part on information provided by at least one reviewer 12, and may include information from a plurality of reviewers. As shown, the rating may include responses to one or more questions related to the rating parameter (e.g., “Does staff respond quickly to calls for assistance?”), and can depict rating results in one or more ways (e.g., bar graph, raw rating score, percentage). Reviewer comments may also be submitted and made available for viewing.

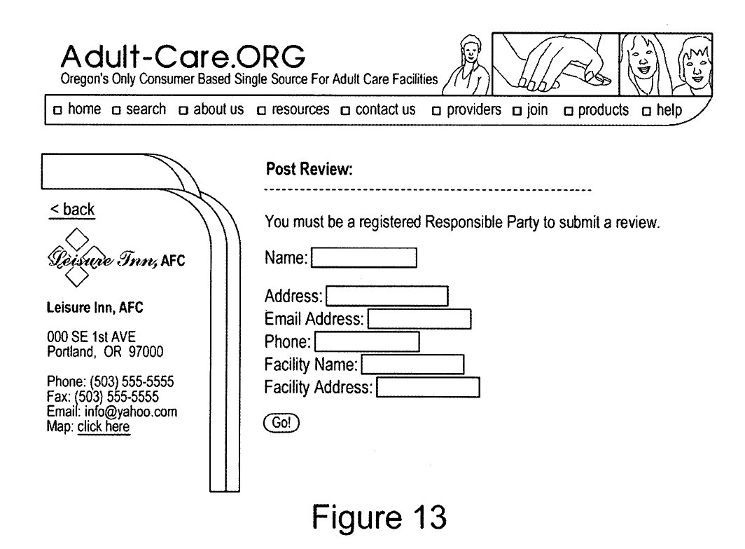

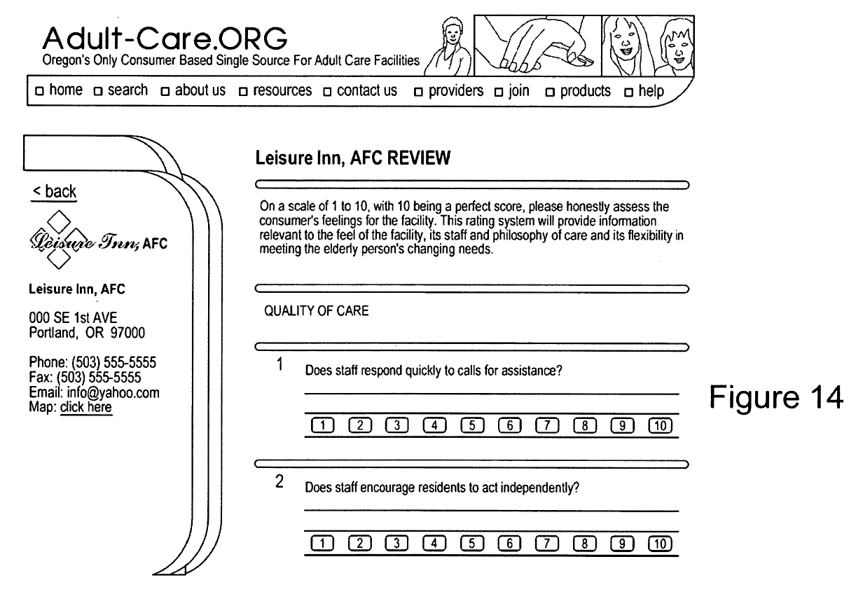

FIGS. 13 and 14 depict embodiments of information entry fields that can be presented to a reviewer or other information submitting entity as a form, for example. The embodiment depicted in FIG. 13 is configured with information prompts (e.g., Name, Address, etc.) to guide the content of a reviewer's responses into specific information types, helping to assure the relevance of answer provided in a data entry field associated with each prompt. For example, FIG. 13 depicts a form configured to collect reviewer identification and contact information, as well as information identifying to which provider the review relates.

FIG. 14 depicts an actual rating form, wherein a reviewer can select a rating level (e.g., 1-n) corresponding to the reviewers assessment of the provider with regard a specific question presented to the reviewer. Answers can be graphical user interface (GUI) buttons selectable by positioning a cursor over a button and pressing an appropriate command (e.g., mouse button, “Enter” key, etc.) to indicate the selection. Alternatively, users could enter comments and/or indicate ratings by text entry using a text entry means (e.g., keyboard, stylus, voice recognition, etc.), although the embodiments are not so limited, and can vary according to the configuration of the reviewer's device 22. As also shown at FIG. 14, instructions can be provided to instruct reviewers regarding the structure (e.g., rating rubric) of the provided rating survey. It is also contemplated that a reviewers answers provided at one portion of a survey can alter the format, content, or even access to another part of the survey with respect to the reviewer.

After providing answers to the survey, an embodiment of the system can present a summary of the reviewer's submitted responses to the reviewer for verification and/or alteration prior to final submission and storage of the responses at a memory means of the service server.

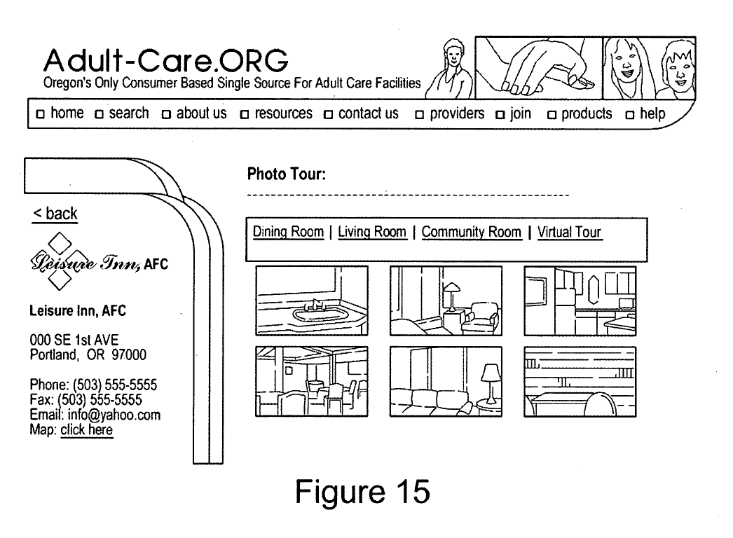

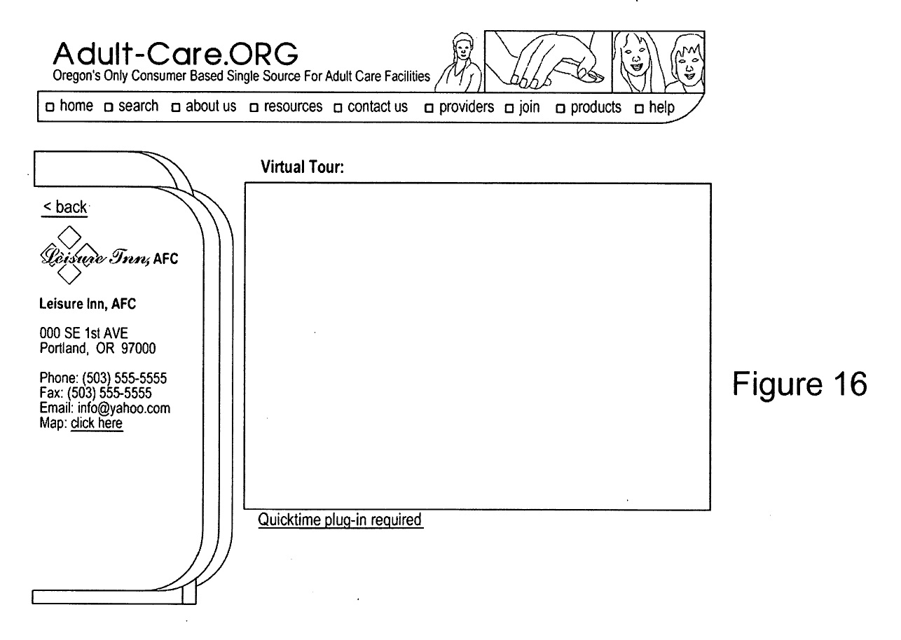

As shown at FIGS. 15 and 16, a user 16 can be presented with numerous options for taking a photographic tour of a provider's facility, and/or can take a virtual tour. A photo tour, as shown in FIG. 15 can include indicating a selection corresponding to a particular interior or exterior portion of a single residential unit (e.g., room, apartment), of community areas of a facility, of areas surrounding the facility, or of any other photographic subject matter that a user may find informative. Choosing a selection (e.g., Dining Room) can cause one or more photographs to be presented to the user as a set. Subsequently indicating another selection (e.g. Living Room) can then cause the first set of photographs to be replaced by another set of photographs relevant to the selection. Users may also select a particular photograph and cause a larger version of the photograph to be presented, therefore providing the user with a more detailed view of the content of that photograph.

A selection can be provided as shown allowing the user to take a virtual tour. FIG. 16 appears to depict a static photograph, and a virtual tour may in fact initially present a static photograph to a user prior to initiation of the tour. However, one having skill in the art will recognize that a virtual tour enables a user to interactively navigate through portions of a facility, and via a motion-based graphical format, view a series of sequential images (whether sequential still photographs or full-motion video) of the facility. As indicated in the figure, accessory software programs (e.g., Quicktime plug-in, etc.) may be necessary for executing a virtual tour in embodiments, although embodiments of the system can include and/or provide such software, either integrated with or accessible by the system.

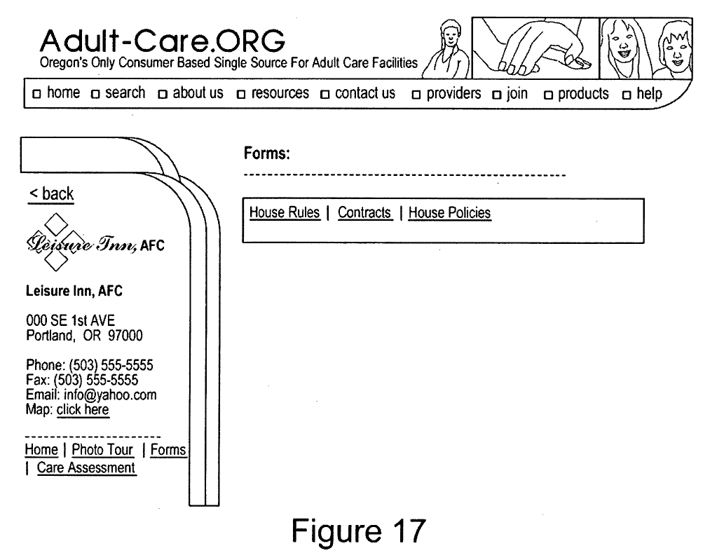

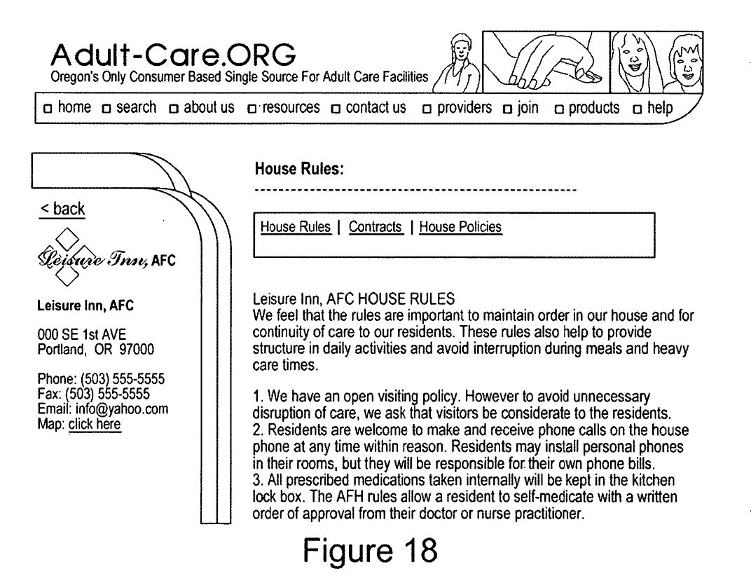

FIG. 17 depicts yet another feature according to embodiments of the invented system, particularly a consolidated access portal for obtaining forms, rules, contracts, and/or other documents relating to or useful for evaluating, selecting, applying for access to, or executing a contract with a provider, although the embodiments are not limited to those listed here. A user can indicate a selection, and as shown at FIG. 18, can be presented with an appropriate document or set of documents (e.g., .pdf, bitmap, html, or in any other format) relating to the user's indicated selection (e.g., Leisure Inn, AFC House Rules, etc.) at the user's device display means.

Alternatively and/or additionally, a user can be presented with a selection option which, when indicated by the user, causes the system to present to the user a means for evaluating one or more aspects of a user's (or another's) adult care needs. This can include such needs as related to mobility, nutrition, medical monitoring, or other parameters of adult care. Based upon and at least partly in response to a user's selections, a system according to embodiments of the invention can then provide to the user a list of providers having facilities, services and/or expertise closely matching the user's selected care parameters.

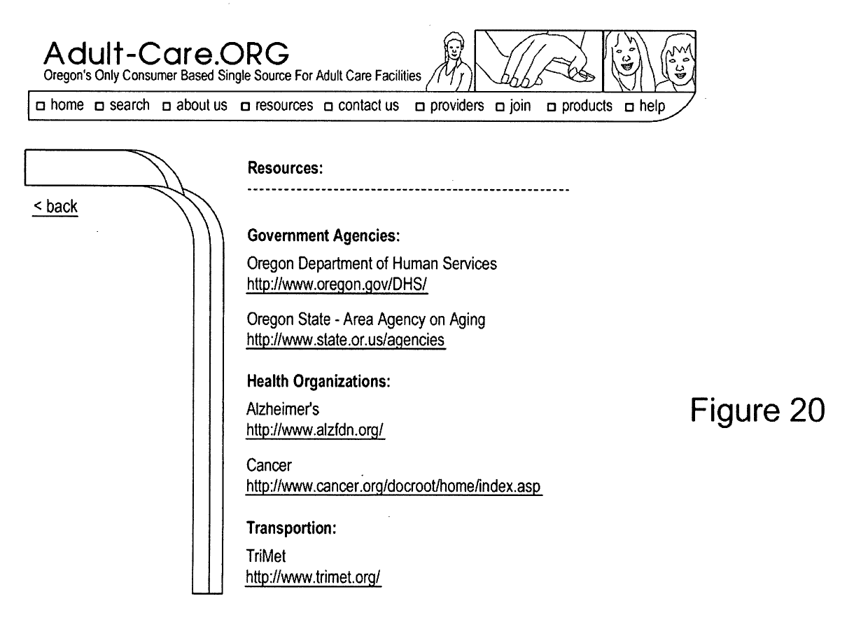

At FIG. 20, an embodiment of the invention includes presenting to the user a listing of resources that provide information or other services related to adult care, and that a user may having an interest or need to contact.

In embodiments, data provided by providers, reviewers, and/or others is cross-checked with one or more other data sources to assess and/or improve the accuracy of the provided data, to reduce data replication, to prevent contrary data, or to otherwise increase the accuracy and/or relevance of data available for presentation to users. Cross-checking could also include comparing a current data and/or time with an activation and/or expiration date of a provider's subscription for system access, for example.

Embodiments of the system can present to a viewer access to any or all portions of the provided information or resources of the system GUI, as described above regarding for example FIGS. 3-20, from any other portion of the system GUI. This access may be provided by tabs, menus, lists, active links, or any other means known in the art. Access may also be provided through voice recognition means interpreting a user's spoken access request. For example, a user can say, “Forms please”, and the system will cause a GUI relating to forms to be presented to the user.

From the foregoing, those of skill in the art will appreciate that several advantages of the present invention include the following.

Embodiments of the present invention provides a relatively centralized information source for users who are potential customers of adult healthcare services and/or facilities. Embodiments of the described system and/or method educate the user, enable the user to perform concise, comprehensive searches for healthcare providers, and evaluate the providers by comparison to other providers. Such comparisons can be made based upon numerous relevant criteria, enabling users to make more informed decisions with a relatively small investment of time.

Users can typically exclude undesirable providers by searching based upon designated criteria, such as access provisions, location, services, Medicaid acceptance, and numerous others. Therefore, users do not waste time considering providers that do not meet the user's needs and/or preferences. User's are also able to quickly see which providers have current and/or expected vacancies, and can exclude from a search any providers not having vacancies.

Users can also see photographs of nearly any portion of the interior, exterior, and/or area surrounding a provider facility, and can take virtual tours of facilities without the need to actually visit the facilities. This is of particular value to user having mobility challenges, or who are located relatively remotely from one or more of the evaluated providers.

Of particular importance, users are presented with information from current and former users of the providers, including complaints, inspection results, and other information that may indicated desirability or undesirability of a facility based on objective and/or subjective historical evaluations. Because the information is provided in embodiments of a system and method operating relatively independently from the providers, the information can be presented to a user in a more complete, impartial and balanced form than information obtained directly from providers. Additionally, embodiments of the system and method enable providers to respond to reviews by customers and/or others, and for users to become aware of those responses.

Embodiments of the system enable retention of relevant information at a central server maintained by a service, readily available to distant, busy, and/or housebound users, among others. Therefore, there is no need for users to contact providers individually to obtain information, nor to retain in physical storage substantial amounts of printed or other media containing the same.

Embodiments of the system provide a system and method for providers to reach large numbers of potential customers with relevant and accurate information about their services and/or facilities. Likewise, providers can readily update their provided information without the need to reprint brochures or other printed media. Therefore, providers can be assured that users are receiving the most recently provided information.

Although a number of advantages of the systems and methods of the invention according to numerous embodiments, the advantages are not limited to those listed herein, and numerous other benefits not previously available in the art are now made enabled. It should also be noted that the numerous embodiments can vary minimally and/or substantially one from another, and not all benefits may be available according to each and every embodiment.

It is further intended that any other embodiments of the present invention that result from any changes in application or method of use or operation, method of manufacture, configuration, format, or arrangement which are not specified within the detailed written description or illustrations contained herein yet are considered apparent or obvious to one skilled in the art are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that a method, system and/or apparatus of the invention may be implemented by a computer or microprocessor process in which instructions are executed, the instructions being stored for execution on a computer-readable medium and being executed by any suitable instruction processor (e.g., processing means).

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A system for providing adult care relevant information, comprising:
a plurality of adult care providers, each having a business ID, location, and facilities to provide adult care services to the public;
a service data network operable to collect adult care relevant data for a plurality of adult care providers, the adult care relevant data retrievable by the public and including one or more of level of care, capacity, food quality, staff qualifications, accreditation, medical care capabilities, accommodations for disabilities, diversity and availability;
a rating engine configurable to the service data network to consolidate the collected adult care relevant data and to provide ratings of the plurality of adult care providers associated with their consolidated adult care relevant data; and
a search engine configurable to the service data network to enable a network user to retrieve one or more of the consolidated care relevant data and associated rating of one or more of the plurality of adult care providers.

2. The system of claim 1, in which the service data network collects the adult care relevant data from the plurality of adult care providers.

3. The system of claim 1, in which the service data network collects the adult care relevant data from an independent reviewer in a form comprising a review, an individual rating, a personal testimonial, and comments.

4. The system of claim 1, in which the service data network is operable to conduct public surveys on adult care providers and collect the adult care relevant data from the surveys results.

5. The system of claim 1, in which the service data network collects the adult care relevant data from government databases.

6. The system of claim 1, in which the service data network collects the adult care relevant data from one or more of vocal reports, printed media, digital storage media, an internet-accessible data transmission device, and a data processing network.

7. The system of claim 6, in which the service data network further comprises a memory device operable to store the adult care relevant data and their associated ratings.

8. The system of claim 7, in which the service data network further comprises an internet-accessible network interface operable to facilitate remote interaction with a user, the user being one or more of an adult care provider, a potential customer, and an independent reviewer.

9. The system of claim 8, in which the service data network further comprises an internet-accessible display operable to facilitate a virtual tour of a facility of one or more of the adult care providers

10. A method for providing adult care relevant information comprising, comprising:
collecting adult care relevant information of a plurality of adult care providers from one or more of the plurality of adult care providers, independent reviewers, government databases, and adult care customers;
consolidating the collected adult care information to generate adult care data;
providing a rating for each of the plurality of adult care providers based on the consolidated adult care data of the adult care provider; and
compiling the adult care data and associated ratings for storage in a service data network, the stored data retrievable by a user of the service data network.
